(19) United States
(12) Patent Application Publication
(10) Pub. No.: US 2009/0251445 A1
(43) Pub. Date: Oct. 8, 2009

(54) DRIVING CIRCUIT FOR A LIQUID CRYSTAL DISPLAY

(75) Inventors: Daisuke ITO, Tokyo (JP); Yoshitoshi Kida, Tokyo (JP); Takeya Takeuchi, Tokyo (JP); David Pusey, Basingstoke (GB); Peter Shadwell, Tadley (GB); Shunsuke Noichi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/418,301

(22) Filed: Apr. 3, 2009

(30) Foreign Application Priority Data
Apr. 4, 2008 (GB) 0806194.7

(51) Int. Cl. G06F 3/038

(52) U.S. Cl. 345/204; 345/87

(57) ABSTRACT

A method of driving a liquid crystal display and a drive circuit for a liquid crystal display module wherein the liquid crystal display of the liquid crystal display module is controlled and the image data displayed by the liquid crystal cells is refreshed. Received frames of image data are analysed to determine if individual frames of image data have characteristics prone to showing flicker. The refresh rate is reduced if the image analysis determines that the frames received of image data do not have characteristics prone to showing flicker.

### BACKGROUND OF THE INVENTION

1. Field of the Invention

The present invention relates to a driving circuit for a liquid crystal display and, in particular, a liquid crystal display module including such a driving circuit and a method of driving a liquid crystal display.

2. Description of the Related Art

Liquid crystal displays are well known using a two-dimensional array of liquid crystal cells in which the cells share a plurality of signal lines in one direction and are selectively enabled by gate lines in a perpendicular direction. Drive circuits are provided which use the gate lines to enable respective sets of liquid crystal cells. The signal lines are then used to provide video signal levels to the enabled cells to charge those cells to the level required to give those cells their desired brightness.

It is usual to group the liquid crystal cells together to form image pixels. Each image pixel would typically include three liquid crystal cells corresponding respectively to red, green and blue. The red, green and blue liquid crystal cells of a pixel are provided on the same gate line and, indeed, can be driven by the same video signal. In particular, with a gate line enabling all of the liquid crystal cells of the pixel, the video signal is provided first to the red liquid crystal cell by means of its signal line, then to the green liquid crystal cell by means of its signal line and finally to the blue liquid crystal cell by means of its signal line.

Liquid crystal displays can be used in electronic devices such as mobile telephones and cameras. Because these devices usually operate from a battery, power consumption is of great concern.

Refreshing the image displayed on the liquid crystal display consumes a relatively large amount of power and, hence, documents such as EP 1 280 129 A have considered the possibility of adjusting the image refresh rate so as to lower the power consumption. In particular, a discrimination section may be used for discriminating whether the image data represents a moving image or a still image. The image refresh rate can be changed accordingly.

### OBJECTS AND SUMMARY OF THE INVENTION

An objective of the present application is to allow the driving of a liquid crystal display with an even greater reduction in power consumption.

According to the present invention, there is provided a method of driving a liquid crystal display having an array of liquid crystal cells for displaying an image. The method includes controlling the liquid crystal display and refreshing the image data displayed by the liquid crystal cells, analysing received frames of image data and determining if individual received frames of image data have characteristics prone to showing flicker and reducing the refresh rate if the image analysis determines that the received frames of image data do not have characteristics prone to showing flicker.

According to the present invention, there is also provided a driving circuit for a liquid crystal display module having an array of liquid crystal cells for displaying an image, the driving circuit being configured to receive consecutive frames of image data respectively for consecutive display via the array of liquid crystal cells. The driving circuit includes a controller configured to control the liquid crystal display module and to refresh the image data displayed by the liquid crystal cells. It also includes an image analysis circuit configured to analyse received frames of image data and to determine if the individual frames of image data have characteristics prone to showing flicker. The controller is configured to reduce the refresh rate if the image analysis circuit determines that the frame of image data does not have characteristics prone to showing flicker.

According to earlier techniques, there was a limit to the extent to which the refresh rate could be reduced merely upon detection that the received frames of data related to still images rather than moving images. It is well known that, in order to present still images without flicker, a minimum refresh rate is required.

The present invention is at least partly based on the recognition that the occurrence of flicker and the minimum refresh rate is determined at least partly by the particular nature of the image to be displayed. It transpires that some still images have artifacts or qualities which make them particularly prone to flicker or at least are more noticeable to the human eye as flicker. Depending upon the arrangement of the liquid crystal display in question, for instance, the arrangement of the liquid crystal display cells and the inversion method which is used, different characteristics for different image frames will be prone to flicker.

By virtue of the present invention, it is possible for the driving circuit to analyse received frames of image data and determine whether or not those frames include any characteristics which will be prone to showing flicker. By carrying out this step of searching for and/or recognising such characteristics, it becomes possible to reduce the refresh rate to a rate below refresh rates previously used for still images. As a result, reduced power consumption for liquid crystal display modules becomes possible.

Preferably, the driving circuit further includes a memory storing a library of data representing at least one image pattern having characteristics prone to showing flicker. The image analysis circuit can be configured to search for such an image pattern in the received frames of image data.

Patterns, such as stripes, tend to present themselves with flicker that is visible to the human eye. The memory stores a library of such patterns. If the image analysis circuit determines that no such patterns can be found or recognised in the received frames of image data, then it is possible for the controller to reduce the refresh rate without danger of flicker becoming apparent to a viewer.

Preferably, the image analysis circuit is configured to determine that a frame of image data has characteristics prone to showing flicker when the image data is intended to display an image that is to be displayed by saturated liquid crystal cells adjacent non-saturated liquid crystal display cells.

Where an image frame includes sub-pixels or pixels at their maximum values (and hence saturates), these sub-pixels or pixels are much less prone to variations in level from one frame to the next. In particular, they will tend to be saturated in adjacent frames even though they are inverted from one potential to another. In contrast, non-saturated liquid crystal cells of sub-pixels or pixels displaying parts of an image in gray or half-tone are prone to variation from one frame to the next, in particular as a result of potential inversion from one frame to the next. As a result, it is noted that image data which is to be displayed by saturated liquid crystal cells adjacent non-saturated liquid crystal cells tends to be prone to showing flicker. Where the image analysis circuit determines that a frame of image data includes such characteristics, the controller can act to avoid reducing the refresh rate.

Preferably the image analysis circuit is configured to determine that a frame of image data has characteristics prone to showing flicker when the image data includes data representing a horizontally striped pattern.

In this respect, horizontal stripes are one example of a type of pattern exhibiting characteristics prone to showing flicker.

Preferably, the image analysis circuit is configured to quantify an extent to which the received frames of image data are not prone to showing flicker.

In this way, the image analysis circuit can provide an indication as to the extent to which a frame of image data is prone to showing flicker.

The controller may be configured to reduce the refresh rate according to the quantified extent.

Thus, a frame of image data found, by the image analysis circuit, to be particularly prone to flicker, will have its refresh rate reduced only by a little, if at all. On the other hand, a received frame of image data found to be only slightly prone to flicker could have its refresh rate reduced greatly.

Preferably, the driving circuit further includes a motion detection circuit configured to compare received frames of image data and to determine if the frames of image data represent a moving image. The controller can be configured not to reduce the refresh rate if the image analysis circuit determines that the frames of image data represent a moving image.

It is also possible for the controller to reduce the refresh rate according to an extent to which the frames of image data represent a moving image. Thus, frames of image data representing a fast moving image may not have the refresh rate reduced at all, whereas frames of image data representing only a slow moving image may have the refresh rate reduced accordingly.

In effect, the controller reduces the refresh rate by dropping received frames of image data. The driving circuit will receive the frames of image data at the standard frame rate, for instance 60 Hz, irrespective of whether those frames of image data contain a moving image or a still image. If there is relatively little movement contained in the successive frames of image data, by dropping a number of successive frames and then using the next frame to refresh the image displayed by the liquid crystal display, the viewer still will not see an unduly jerky motion. Of course, for a still image, where there are no significant characteristics prone to showing flicker, the reduced refresh rate can similarly be achieved by dropping successive received frames of image data between refreshing the image displayed by the liquid crystal display.

The present invention may be embodied in a liquid crystal module including not only the driving circuit but also a liquid crystal display.

Such a liquid crystal module may be provided as part of any suitable device, such a camera or mobile telephone.

### BRIEF DESCRIPTION OF THE DRAWINGS

FIG. 1 illustrates a mobile telephone in which the present invention may be embodied;

FIG. 2 illustrates a camera in which the present invention may be embodied;

FIG. 3 illustrates a liquid crystal display module in which the present invention may be embodied;

FIG. 4 illustrates schematically three pixel units of a pixel of a liquid crystal display;

FIG. 5 illustrates the timing of signals for driving the pixel units of FIG. 4;

FIG. 6 illustrates a driving circuit embodying the present invention;

FIG. 7 illustrates power reduction resulting from reduced refresh rate;

FIG. 8 illustrates how flicker can arise on a striped display;

FIG. 9 illustrates how flicker is less visible on a gray display;

FIGS. 10(a), (b) and (c) illustrate different inversion methods for liquid crystal displays;

FIGS. 11(a), (b) and (c) illustrate a variety of types of image; and

FIG. 12 illustrates the analysis of predetermined areas of an image frame.

### DETAILED DESCRIPTION OF THE PREFERRED EMBODIMENTS

The invention will be more clearly understood from the following description, given by way of example only, with reference to the accompanying drawings.

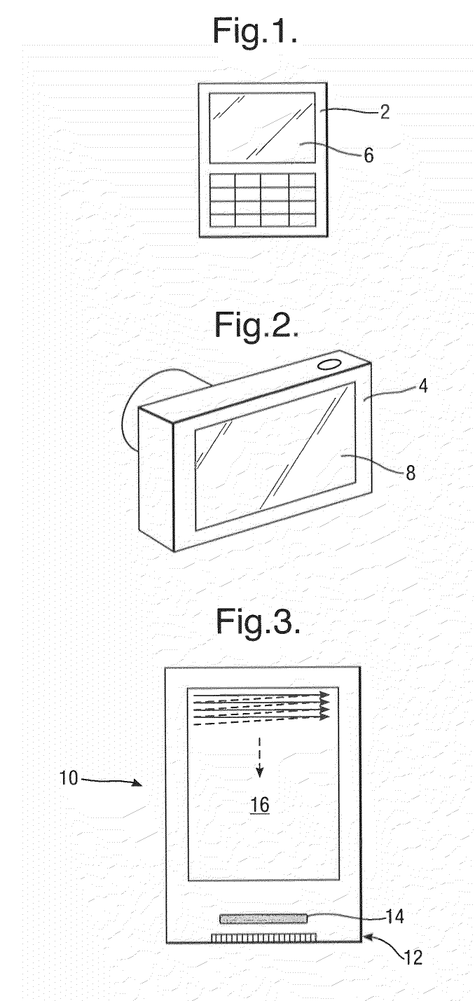

The present invention is applicable to LCD (Liquid Crystal Display) modules such as are used in mobile telephone devices or digital cameras, for instance as illustrated respectively in FIGS. 1 and 2. Other examples include portable gaming devices and personal media players. The present invention could be applied to any LCD, including those with LCD driving circuits formed on the display panel of the LCD module itself.

In the mobile telephone device 2 of FIG. 1 and the digital camera 4 of FIG. 2, respective LCD modules 6 and 8 are provided for displaying images as required.

FIG. 3 illustrates an LCD module 10 which is suitable for use in mobile telephone devices and digital cameras and which embodies the present invention.

The LCD module 10 includes at least one plate 12 made of glass (or any other suitable transparent material) against which a liquid crystal display 16 is formed in any known manner. In the illustrated embodiment, a driving circuit 14 is also formed on the glass plate 12. An LCD driving circuit 14 according to the present invention is illustrated at a lower portion of the display module 10, a similar driving circuit could be provided at any portion of the glass plate 12 around the display area 16 or, indeed, in a distributed manner around the display area 16. It could also be provided separately from the module 10.

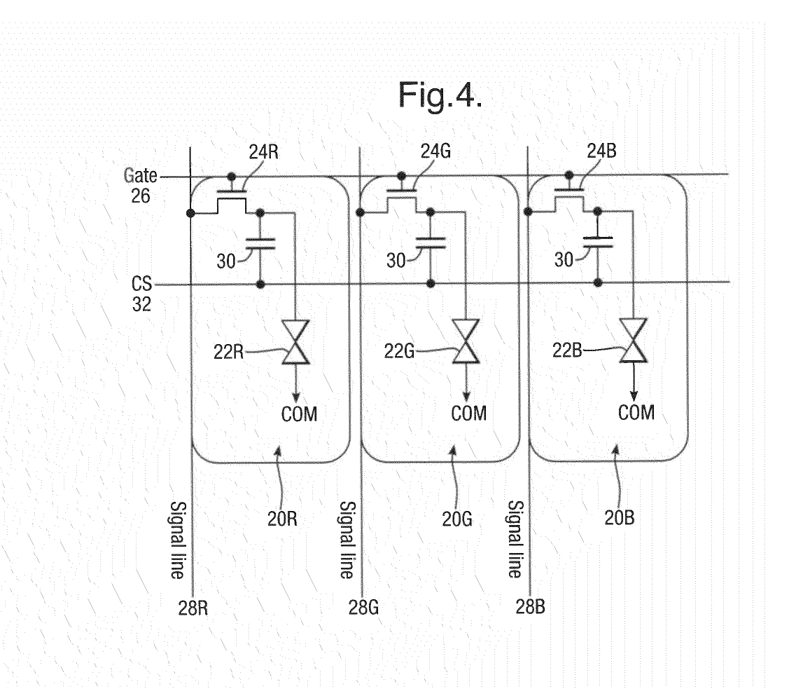

FIG. 4 illustrates one example of how the display area 16 can be implemented.

The display area 16 is divided into a two-dimensional array of pixels. The pixels extend in horizontal rows in a first direction and in vertical columns in a second direction. By activating each pixel with a desired colour and brightness, an appropriate image can be displayed on the display 16.

In order to produce a variety of different colours, each pixel includes three pixel units 20R, 20G, 20B (otherwise known as sub-pixels) respectively for producing red, green and blue. FIG. 4 illustrates the three pixel units 20R, 20G, 20B of a pixel arranged side by side in the first (horizontal) direction. In this respect, it should be appreciated that the three pixel units 20R, 20G, 20B should be located close to one another in order to provide the desired visual combined colour, but the exact positioning of the pixel units is not critical.

Each of the pixel units 20R, 20G, 20B includes a corresponding liquid crystal cell 22R, 22G, 22B. One side of every liquid crystal cell 22R, 22G, 22B is connected to a common line COM which, in the preferred embodiment, is formed as part of the glass plate 12 itself. The opposite side of each liquid crystal cell 22R, 22G, 22B is connected to a respective control transistor or switch 24R, 24G, 24B.

As illustrated, all of the switches 24R, 24G, 24B in a row are controlled, in other words switched on or off, by means of a common gate line 26. A respective gate line is provided for each of the rows of the display 16. On the other hand, the inputs to the switches 24R, 24G, 24B are connected to signal lines 28R, 28G, 28B. In particular, all of the red pixel units 20R in the same column are connected to a single respective signal line 28R, all of the green pixel units 20G in the same column are connected to a single respective signal line 28G and all of the blue pixel units 20B in the same column are connected to a single respective signal line 28B.

In order to display an image on the display area 16 of the LCD module 10, an image is provided row by row. A particular gate line 26 is driven to a voltage so as to turn on all of the switches or transistors 24R, 24G, 24B in its respective row. While that gate line enables that particular row or horizontal line, first all of the red signal lines 28R are used to drive all of the red liquid crystal cells 22R in that row, then all of the green signal lines 28G are used to drive all of the green LCD cells 22G in that particular row and, finally, all of the blue signal lines 28B are used to drive all of the blue liquid crystal cells 22B in that particular row. Preferably, all of the pixel units 20R, 20G, 20B of a particular colour are driven simultaneously. However, other arrangements are also possible.

With one row or horizontal line written, the corresponding gate line 26 is driven to a voltage to turn off all of its corresponding switches or transistors 24R, 24G, 24B and another gate line is driven to a voltage to turn on its corresponding switches. Adjacent gate lines 26 can be driven one after the other, but other arrangements are possible. It will also be appreciated that different arrangements of arrays of pixel units can be provided to achieve the same effect.

In practice, the liquid crystal capacitance is somewhat variable and it becomes difficult, with only the arrangement described above, to drive reliably the liquid crystal cells 22R, 22G, 22B to the appropriate or desired brightness levels. To help compensate for the variability of the liquid crystal cells 22R, 22G, 22B, CS capacitors 30 are provided in parallel with the liquid crystal cells 22R, 22G, 22B. As illustrated, the CS capacitors 30 are provided between the signal driving end of the liquid crystal cells 22R, 22G, 22B and a CS line 32. For the arrangement described above, a CS line 32 is provided for each respective row or horizontal line. Thus, the CS capacitors 30 of all of the pixel units 20R, 20G, 20B of a respective row or horizontal line are connected to a corresponding respective CS line 32.

The CS line 32 is driven with a voltage corresponding closely to the voltage of the common voltage COM. In this way, variations in the capacitance of the liquid crystal cells 22R, 22G, 22B have less effect on driving of those liquid crystal cells 22R, 22G, 22B.

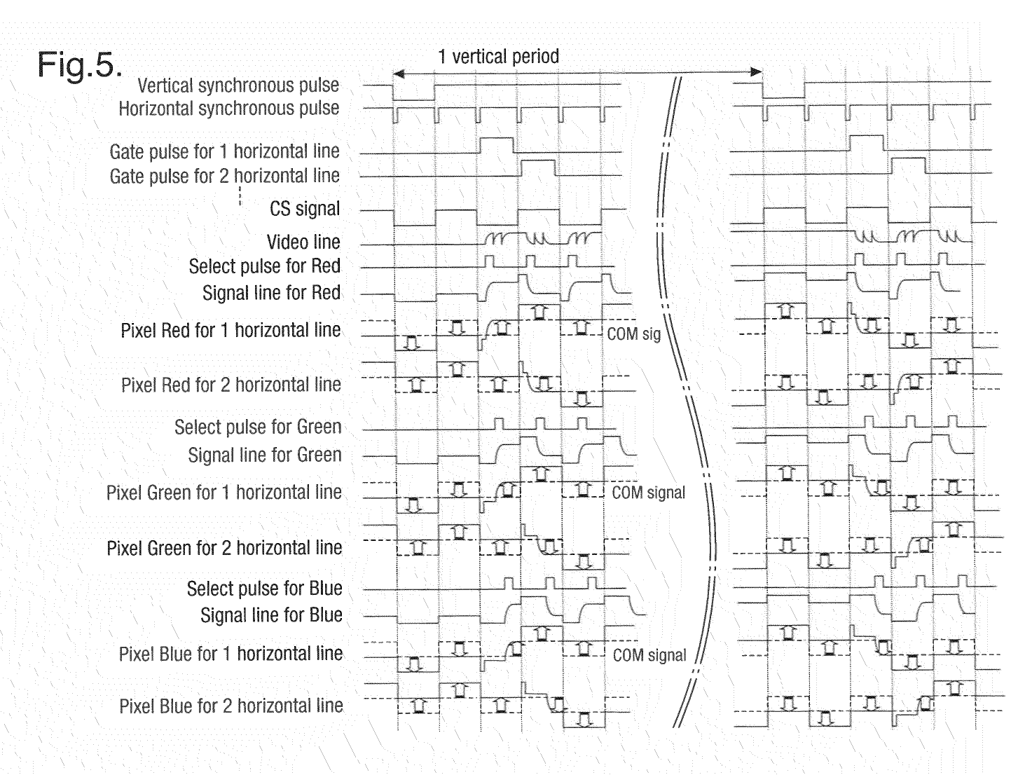

FIG. 5 illustrates various signals for driving the first two horizontal lines of the display 16. In this regard, it is worth noting that, for ongoing operation of the liquid crystal display 16, it is necessary to reverse the polarity applied to the liquid crystal cells 22R, 22G, 22B each time they are used; this is known as inversion. Hence, after each frame is displayed on the display 16, in other words after each vertical period, the polarity is reversed. Also, adjacent horizontal lines or rows are driven with opposite polarities.

As illustrated in FIG. 5, a vertical synchronous pulse having the length of one horizontal timing signifies a new frame. Also, a short horizontal synchronous pulse is provided to indicate each new horizontal line or row.

Gate pulses are shown for the first and second horizontal lines. Each gate pulse lies within the horizontal line period and, during a gate pulse, the respective row or horizontal line of pixel units 20R, 20G, 20B are enabled in the manner described above. Thus, during the gate pulse for the first horizontal line, all of the switches/transistors 24R, 24G, 24B of the first horizontal line are enabled, but none others. Similarly, for the second horizontal gate pulse, only the switches/transistors of the second row or horizontal line are enabled.

In FIG. 5, the voltages for a red pixel unit 20R, a green pixel unit 20G and a blue pixel unit 20B are indicated for first and second horizontal lines. The COM signal is illustrated as a dashed line overlying the voltage illustrated for the liquid crystal cells 22R, 22G, 22B of the pixel units 20R, 20G, 20B. As illustrated, from one horizontal line to the next, the COM signal changes from one voltage state to another. In this way, the polarity applied to adjacent horizontal rows of pixels is reversed. As also illustrated, for the second vertical period (on the right side of FIG. 5), the COM signal is reversed as a whole such that the pixels of a horizontal line are driven with opposite polarity from frame to frame.

The CS signal follows the COM signal with generally the same voltage.

The COM signal and CS signal change can state between zero volts and approximately 5 volts.

Within each horizontal period, respective select pulses are provided for the red pixel units 20R, green pixel units 20G and blue pixel units 20B. In this way, a common video line can be provided for one pixel, that video line including consecutively the driving signal required for the red pixel unit 20R, green pixel unit 20G and blue pixel unit 20B of the same pixel. The select pulses illustrated in FIG. 5 are used to apply appropriate portions of the video line signal to the respective red, green and blue pixel units 20R, 20G, 20B. As a result, during a particular respective select pulse, the signal line for the respective pixel unit 20R, 20G, 20B is driven to the required voltage provided by the common video line signal at that time.

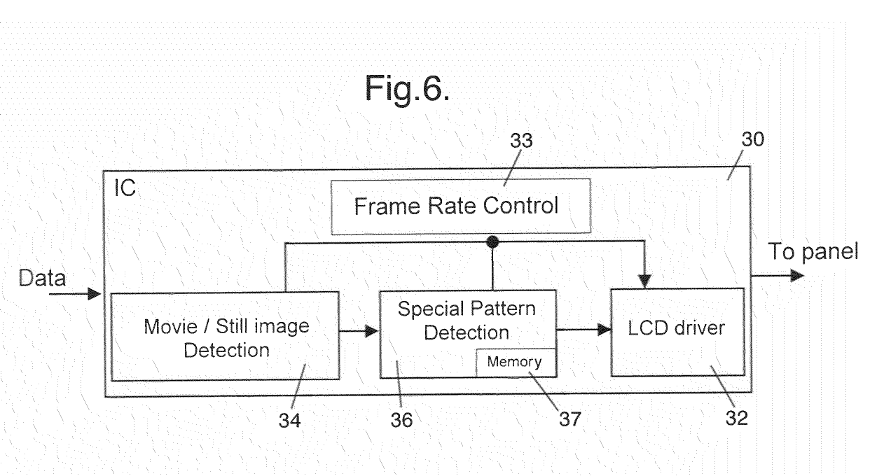

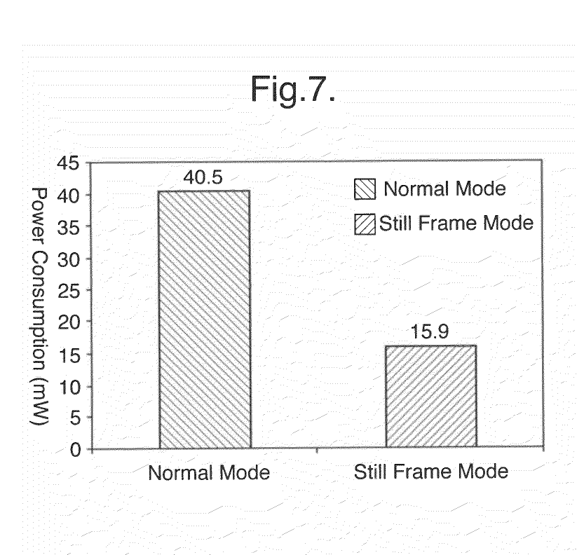

FIG. 6 illustrates schematically a driving circuit 30, such as driving circuit 14, for a liquid crystal display which is provided in order to reduce the overall power consumption of the liquid crystal display module. All illustrated, the driving circuit 30 may be implemented as part of an integrated circuit with a liquid crystal display driver 32 of generally conventional design. Normally, the refresh rate (the frequency at which field/frames are rewritten to the liquid crystal display) is set to approximately 50 Hz or 60 Hz as required. This allows display of moving pictures and prevents visible flicker.

The driving circuit 30 of FIG. 6 includes a frame rate control 33 for controlling the LCD driver 32 to reduce the refresh rate. Each time a liquid crystal display is refreshed, the various components of that display have to be activated and capacitive components, such as the COM line have to be charged. Hence, reducing the refresh rate can substantially reduce the power consumption.

FIG. 7 illustrates an example of power consumption for a typical liquid crystal display module operating with a normal refresh rate and a similar liquid crystal display module operating with a reduced refresh rate as proposed by the present invention. As can be seen from FIG. 7, power consumption can be reduced by almost 15 mW.

As illustrated, the embodiment of FIG. 6 includes, as part of the driving circuit 30, a moving/still image detection circuit 34. Data signals received by the driving circuit 30 are analysed by the moving/still image detection circuit 34 so as to establish whether or not those data signals represent a moving image. For instance, the moving/still image detection circuit 34 can carry out a comparison between consecutive fields/frames so as to detect any movement. Frames may be compared by storing them temporarily in memory. Alternatively, the image data received may be analysed. For example, compressed image data may include motion vectors. Where motion vectors are detected, they may be compared to a threshold value, and where they are above the threshold value the data is determined as representing moving images.

If the moving/still image detection circuit 34 determines that the received data related to moving images, then the standard refresh rate is maintained by the frame rate control 33. However, if the received data related to a still image, it is possible to reduce the refresh rate. As explained below, it is also possible that the frame rate is reduced in some proportion to the speed of the moving image so that, if an image is slowly moving, the refresh rate is decreased by only a small amount.

The extent to which the refresh rate can be reduced will depend partly on the rate at which the displayed image provided by the liquid crystal display cells decays. If the displayed image has started to decay and is then refreshed, an undesirable flicker will be presented to the viewer. In this respect, it is expected that refresh rates as low as 1 Hz might be possible.

Unfortunately, reducing the refresh rate below the normal refresh rate can also create apparent flicker.

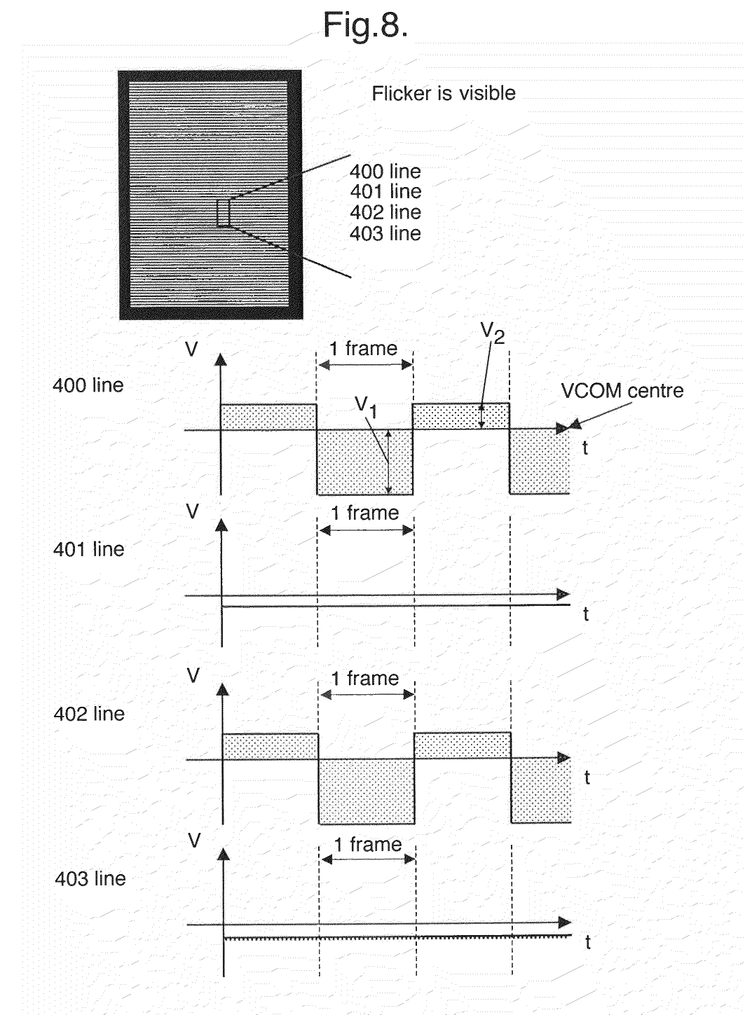

FIG. 8 illustrates the display of an horizontally striped pattern with consecutive light and dark horizontal stripes.

Because of imperfections in the drive circuitry which will inevitably be present, for lines such as line 400 and line 402, the liquid crystal display cells will be driven to a large potential V₁ relative to the V-COM centre in one frame and to a relatively small potential V₂ relative to the V-COM centre in the next frame. This results from a slight offset of the V-COM centre. On the other hand, for lines such as lines 401 and 403, there will be little change. As it happens, the human eye will be sensitive to the gray level changes from frame to frame.

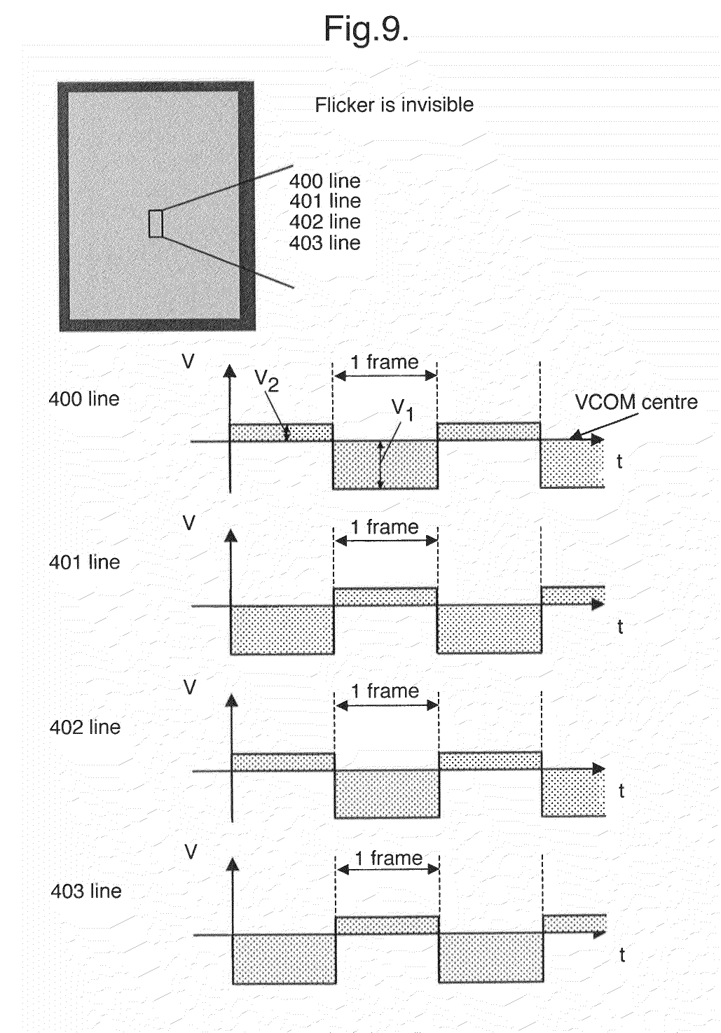

In the arrangement of FIG. 9, where an entire screen of gray is displayed, although the same gray level changes will occur from frame to frame, these are interlaced with other lines having similar, but opposite gray level changes. As a result, the flicker is much less perceptible to the human eye.

It is found that flicker will be particularly noticeable where gray or half-tone is located next to fully saturated levels. The fully saturated levels will remain constant from frame to frame whereas the gray levels will firstly tend to vary from frame to frame and secondly be more prone to decay during a frame.

Horizontal patterns have also been shown to be more prone to displaying flicker.

It is well known that liquid crystal displays can be driven with different types of inversion method whereby the polarity of the liquid crystal display cells are inverted each frame.

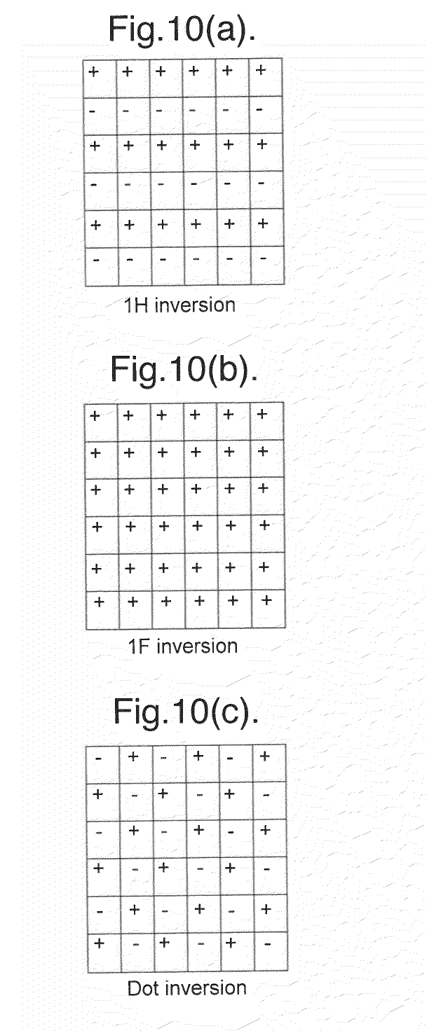

FIG. 10(a), (b) and (c) illustrate respectively a) a 1 H inversion arrangement where each horizontal line has the same polarity but is inverted each frame, b) a 1 F inversion method where all cells of a frame have the same polarity and are inverted each frame and c) a dot inversion method where adjacent cells have different polarity and are inverted each frame.

These different inversion methods may be prone to showing flicker with different respective types of pattern.

Returning to FIG. 6, it will be seen that the driving circuit 30 includes a special pattern detection circuit 36. The special pattern detection circuit 36 is configured to detect, in a frame of data received for display, patterns which are prone to flicker. In this respect, the special pattern detection circuit 36 can include parts configured to search for and recognise particular features of an image, for instance horizontal striping, half-tone areas next to saturated areas etc. It may also include a library of patterns (stored in memory 37) prone to flicker and search for those patterns in the received data. The precise nature of the special pattern detection circuit 36 and the patterns which it searches for and detects will vary according to the inversion method used. Also, the patterns searched for will vary according to the extent to which the refresh rate is to be reduced.

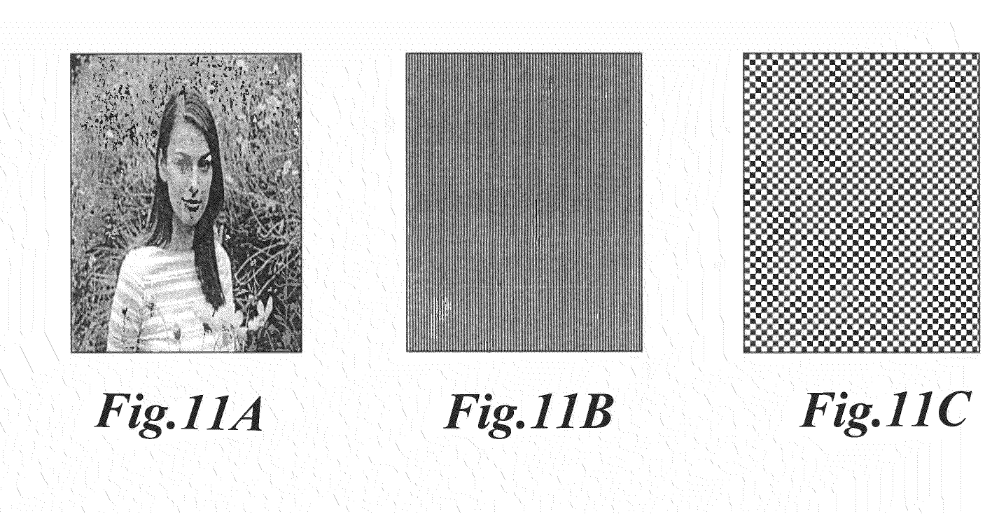

If the special pattern detection circuit 36 does not detect any patterns in the received data which are prone to flicker, then the driving circuit can control the frame rate of the LCD driver 32 so as to reduce the refresh rate. With a fairly standard natural image as illustrated in FIG. 11(a), frame rate can be reduced to 15 Hz. With grey horizontal stripes as illustrated in FIG. 11(b), reduction of frame rate is usually not possible. With a saturated black and white image as illustrated in FIG. 11(c), frame rate can be reduced to 1 Hz.

As the refresh rate is reduced, flicker becomes potentially a greater problem. Hence, the special pattern detection circuit 36 can be configured to look for different patterns associated with different degrees of apparent flicker and to detect to which extent an image is prone to showing flicker. In this way, it is also possible for the driving circuit 30 to reduce the refresh rate of the LCD driver 32 selectively according to the likely apparent flicker in the image. Images containing patterns which are only slightly prone to flicker may have the refresh rate reduced by a large amount, whereas images containing patterns which are highly prone to flicker, may have refresh rates reduced by only a small amount, if at all.

Considering again the moving/still image detection circuit 34, it should be noted that this can be used continuously so as to vary the refresh rate on a frame by frame basis. Thus, in the middle of a video sequence, if it is detected that there is little or no movement, the moving/still image detection circuit 34 can be configured to allow the driving circuit to control the frame rate of the LCD driver 32 to reduce the refresh rate as possible. Indeed, it is also possible for the moving/still image detection circuit 34 to provide information to allow the frame rate to be controlled according to the amount of motion. Hence, if the moving/still image detection circuit 34 detects that the image is changing only slowly, then it would be possible to reduce the refresh/frame rate. However, if the moving/still image detection circuit 34 detects that there is a fast moving quality to the received data, then the frame rate would be held at its normal rate.

In order to simplify the processing conducted by the moving/still image detection circuit 34 and the special pattern detection circuit 36, in one embodiment, one or both of the circuits 34, 36 can be configured to analyse received data relating only to certain portions of the image to be displayed.

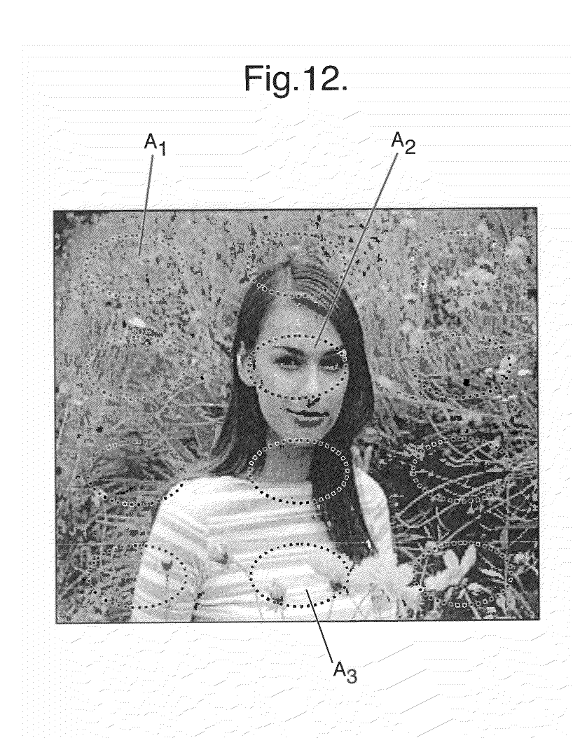

FIG. 12 illustrates schematically an array of 12 areas A₁, A₂, A₃ in a single field/frame of displayed image in which analysis might be conducted. By spreading areas of analysis across an image frame, it becomes possible to obtain a good overall representation of whether or not movement is occurring in the image or if the image includes a pattern prone to flicker.

By way of example, for FIG. 11, area A₁ is likely to show no movement and not be prone to flicker. Area A₂ may or may not register as a moving image depending upon whether the subject in the image is moving. Finally, area A₃ includes a horizontal striped pattern which might be determined by the pattern detection circuit 36 to be prone to flicker.

If the moving/still image detection circuit 34 detects movement in area A₂ or if the special pattern detection circuit 36 determines that the pattern in area A₃ is prone to flicker, the refresh rate for the image shown in FIG. 11 will not be reduced. However, otherwise, the driving circuit 30 may cause the LCD driver 32 to reduce the refresh rate.

We claim:

1. A driving circuit for a liquid crystal display module having an array of liquid crystal cells for displaying an image, the driving circuit being configured to receive consecutive frames of image data respectively for consecutive display via the array of liquid crystal cells, the driving circuit including:
a controller configured to control the liquid crystal display module and to refresh the image data displayed by the liquid crystal cells;
an image analysis circuit configured to analyse received frames of image data and to determine if the individual received frames of image data have characteristics prone to showing flicker; wherein
the controller is configured to reduce the refresh rate if the image analysis circuit determines that the received frames of image data do not have characteristics prone to showing flicker.

2. A driving circuit according to claim 1 further including:
a memory storing a library of data representing at least one image pattern having characteristics prone to showing flicker; wherein
the image analysis circuit is configured to search for said image patterns in the received frames of image data.

3. A driving circuit according to claim 2 wherein the image analysis circuit is configured to determine that a frame of image data has characteristics prone to showing flicker where the image data is to be displayed by saturated liquid crystal cells adjacent non-saturated liquid crystal cells.

4. A driving circuit according to claim 1 wherein the image analysis circuit is configured to determine that a frame of image data has characteristics prone to showing flicker where the image data is to be displayed by saturated liquid crystal cells adjacent non-saturated liquid crystal cells.

5. A driving circuit according to claim 1 wherein the image analysis circuit is configured to determine that a frame of image data has characteristics prone to showing flicker when the image data includes data over a sequence of frames representing a horizontally striped pattern.

6. A driving circuit according to claim 2 wherein the image analysis circuit is configured to determine that a frame of image data has characteristics prone to showing flicker when the image data includes data over a sequence of frames representing a horizontally striped pattern.

7. A driving circuit according to claim 3 wherein the image analysis circuit is configured to determine that a frame of image data has characteristics prone to showing flicker when the image data includes data over a sequence of frames representing a horizontally striped pattern.

8. A driving circuit according to claim 1 wherein:
the image analysis circuit is configured to quantify an extent to which the received frames of image data are not prone to showing flicker; and
the controller is configured to reduce the refresh rate according to the quantified extent.

9. A driving circuit according to claim 8 further including:
a motion detection circuit configured to compare received frames of image data and to determine if the frames of image data represent a moving image; wherein
the controller is configured not to reduce the refresh rate if the image analysis circuit determines that the frames of image data represent a moving image.

10. A driving circuit according to claim 1 further including:
a motion detection circuit configured to compare received frames of image data and to determine if the frames of image data represent a moving image; wherein
the controller is configured not to reduce the refresh rate if the image analysis circuit determines that the frames of image data represent a moving image.

11. A liquid crystal module including a liquid crystal display having an array of liquid crystal cells for displaying an image and including a driving circuit, the driving circuit being configured to receive consecutive frames of image data respectively for consecutive display via the array of liquid crystal cells, the driving circuit further including:
a controller configured to control the liquid crystal display module and to refresh the image data displayed by the liquid crystal cells;
an image analysis circuit configured to analyse received frames of image data and to determine if the individual received frames of image data have characteristics prone to showing flicker; wherein
the controller is configured to reduce the refresh rate if the image analysis circuit determines that the received frames of image data do not have characteristics prone to showing flicker.

12. A mobile telephone comprising a liquid crystal module including a liquid crystal display having an array of liquid crystal cells for displaying an image and including a driving circuit, the driving circuit being configured to receive consecutive frames of image data respectively for consecutive display via the array of liquid crystal cells, the driving circuit further including:
a controller configured to control the liquid crystal display module and to refresh the image data displayed by the liquid crystal cells;
an image analysis circuit configured to analyse received frames of image data and to determine if the individual received frames of image data have characteristics prone to showing flicker; wherein
the controller is configured to reduce the refresh rate if the image analysis circuit determines that the received frames of image data do not have characteristics prone to showing flicker.

13. A camera comprising a liquid crystal module including a liquid crystal display having an array of liquid crystal cells for displaying an image and including a driving circuit, the driving circuit being configured to receive consecutive frames of image data respectively for consecutive display via the array of liquid crystal cells, the driving circuit further including:
a controller configured to control the liquid crystal display module and to refresh the image data displayed by the liquid crystal cells;
an image analysis circuit configured to analyse received frames of image data and to determine if the individual received frames of image data have characteristics prone to showing flicker; wherein
the controller is configured to reduce the refresh rate if the image analysis circuit determines that the received frames of image data do not have characteristics prone to showing flicker.

14. A method of driving a liquid crystal display having an array of liquid crystal cells for displaying an image, the method including:
controlling the liquid crystal display and refreshing the image data displayed by the liquid crystal cells;
analysing received frames of image data and determining if individual received frames of image data have characteristics prone to showing flicker; and
reducing the refresh rate if the image analysis determines that the received frames of image data do not have characteristics prone to showing flicker.
